(19) United States
(12) Patent Application Publication
(10) Pub. No.: US 2008/0222312 A1
(43) Pub. Date: Sep. 11, 2008

(54) APPARATUS AND METHOD FOR OPTIMIZING USE OF A MODEM JACK

(75) Inventor: Christopher F. Simanonis, Winfield, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: WESTELL TECHNOLOGIES, INC., Aurora, IL (US)

(21) Appl. No.: 11/936,529

(22) Filed: Nov. 7, 2007

Related U.S. Application Data
(60) Provisional application No. 60/893,955, filed on Mar. 9, 2007.

(51) Int. Cl. G06F 13/12

(52) U.S. Cl. 710/10

(57) ABSTRACT

An apparatus and method are disclosed for optimizing use of a modem jack. For a computer system that includes a modem, an apparatus may include a first branch including a first end that is arranged to connect to an Ethernet jack of the modem, a second branch including a second end that is arranged to connect to an Ethernet interface of the computer system, and a third branch including a third end that is arranged to connect to a USB interface of the computer system. The Ethernet jack of the modem will then receive both Ethernet and USB signals.

### PRIORITY

This application claims the benefit of priority of U.S. Provisional Application No. 60/893,955, filed Mar. 9, 2007; the disclosure of which is explicitly incorporated by reference herein.

### FIELD

The present application relates generally to modem jacks, and more particularly, relates to a modem jack that can be used for both Ethernet and USB signals.

### BACKGROUND

Digital subscriber line (“DSL”) modems and gateways are quickly becoming commodity devices. Many manufacturers wish to realize hardware-cost savings associated with producing and perhaps operating these devices. Generally, a DSL modem or gateway provides three different types of data jacks: an RJ-11 jack, an Ethernet jack, and a universal serial bus (“USB”) client jack. One or more of each of these jacks may be provided on a DSL modem or gateway.

The RJ-11 jack is typically provided as an interface to a service provider's DSL wide area network (“WAN”). The Ethernet jack is usually provided for a customer-facing local area network (LAN)-side connection, typically for situations where the end-user or customer needs an Ethernet-based LAN-side interface. The LAN-side connection may be a personal computer (“PC”) or router, for example. The USB client jack is also typically provided for the customer-facing LAN-side connection.

Although a DSL modem or gateway, for instance, may include two different LAN-side interface jacks, such as Ethernet and USB jacks, the two jacks are typically configured in an “either-or” configuration. That is, if the user interfaces to the Ethernet jack, the USB jack is disabled and visa-versa.

### SUMMARY

Since typical Ethernet and USB jacks on a DSL modem are arranged in an “either-or” configuration, hardware costs associated with such modems can be burdened by the cost of an extra and perhaps unused jack. It would be beneficial to eliminate the cost of this extra jack. As such, an apparatus and method are disclosed for optimizing use of a modem jack.

In one aspect, an embodiment of the present application may take the form of an apparatus. For a computer system that includes a modem, the apparatus includes a first branch including a first end that is arranged to connect to an Ethernet jack of the modem, a second branch including a second end that is arranged to connect to an Ethernet interface of the computer system, and a third branch including a third end that is arranged to connect to a USB interface of the computer system.

In an example, the first branch is arranged to carry Ethernet and USB signals, the second branch is arranged to carry Ethernet signals, and the third branch is arranged to carry USB signals.

In one instance, the first end includes eight conductor pins, the Ethernet jack of the modem includes eight conductors, and the eight conductor pins of the first end are arranged to connect to the eight conductors of the Ethernet jack. In another instance, four of the eight conductor pins of the first end are used for Ethernet signals, and the remaining four of the eight conductor pins of the first end are used for USB signals. In yet another instance, the four of the eight conductor pins used for Ethernet signals are arranged to connect to four of the eight conductors of the Ethernet jack, and the remaining four of the eight conductor pins used for USB signals are arranged to connect to the remaining four of the eight conductors of the Ethernet jack.

In one case, the second end includes a first group of conductor pins arranged to connect to the Ethernet interface of the computer system, and the third end includes a second group of conductor pins arranged to connect to the USB interface of the computer system.

In an example, the first branch includes eight conducting wires, the second branch includes four of the eight conducting wires, and the third branch includes the remaining four of the eight conducting wires. In another example, the eight conducting wires of the first branch are cooperatively arranged to carry Ethernet and USB signals, the four of the eight conducting wires of the second branch are arranged to carry Ethernet signals, and the remaining four of the eight conducting wires of the third branch are arranged to carry USB signals.

In one instance, the modem includes at least one of a DSL modem, a cable modem, and an analog modem. In another instance, the first and second branches include a 10/100baseT-cable-wiring and pin-out configuration. In yet another instance, the modem includes the Ethernet jack at the exclusion of a USB jack.

In another aspect, an embodiment of the present invention may take the form of a method. In a computer system that includes an Ethernet interface, a USB interface, and a modem, the method includes, via a cable, routing Ethernet and USB signals from the Ethernet and USB interfaces, respectively, to an Ethernet jack of the modem; routing Ethernet signals from the Ethernet jack of the modem to the Ethernet interface via the cable; and routing USB signals from the Ethernet jack of the modem to the USB interface via the cable.

In an example, the cable includes (i) a first branch that includes a first end arranged to connect to the Ethernet jack of the modem, (ii) a second branch that includes a second end arranged to connect to the Ethernet interface, and (iii) a third branch that includes a third end arranged to connect to the USB interface.

In one example, routing Ethernet and USB signals from the Ethernet and USB interfaces, respectively, to the Ethernet jack of the modem includes enabling the first branch to carry Ethernet and USB signals. In another example, routing Ethernet signals from the Ethernet jack of the modem to the Ethernet interface via the cable includes enabling the second branch to carry Ethernet signals. In yet another example, routing USB signals from the Ethernet jack of the modem to the USB interface via the cable includes enabling the third branch to carry USB signals.

In one instance, the first end includes eight conductor pins, the Ethernet jack of the modem includes eight conductors, and the eight conductor pins of the first end are arranged to connect to the eight conductors of the Ethernet jack. In another instance, four of the eight conductor pins of the first end are used for Ethernet signals, and the remaining four of the eight conductor pins of the first end are used for USB signals.

In an example, the first branch includes eight conducting wires, the second branch includes four of the eight conducting wires, and the third branch includes the remaining four of the eight conducting wires. In another example, the eight conducting wires of the first branch are cooperatively arranged to carry Ethernet and USB signals, the four of the eight conducting wires of the second branch are arranged to carry Ethernet signals, and the remaining four of the eight conducting wires of the third branch are arranged to carry USB signals.

In yet another aspect, an embodiment of the present invention may take the form of another apparatus. For a computer system that includes a modem, the apparatus includes a first end arranged to connect to an Ethernet jack of the modem, the modem including the Ethernet jack at the exclusion of a USB jack. The apparatus further includes a split-end that includes (i) a second end arranged to connect to an Ethernet interface of the computer system and (ii) a third end arranged to connect to a USB interface of the computer system.

These as well as other aspects and advantages will become apparent to those of ordinary skill in the art by reading the following detailed description, with appropriate reference to the accompanying drawings.

### BRIEF DESCRIPTION OF THE DRAWINGS

Various embodiments are described herein with reference to the following drawings, wherein like numerals denote like entities.

FIG. 1 is a block diagram of a modem, according to an example;

FIG. 2 is a block diagram of a cabling configuration, according to an example;

FIG. 3A is a block diagram of another cabling configuration, according to an example;

FIG. 3B is a block diagram of another modem, according to example;

FIG. 4 is a block diagram of a cable, according to an example;

FIG. 5 is a schematic diagram of the cable of FIG. 4, according to an example; and

FIG. 6 is a flow chart of a method, according to an example.

### DETAILED DESCRIPTION

### 1. Overview

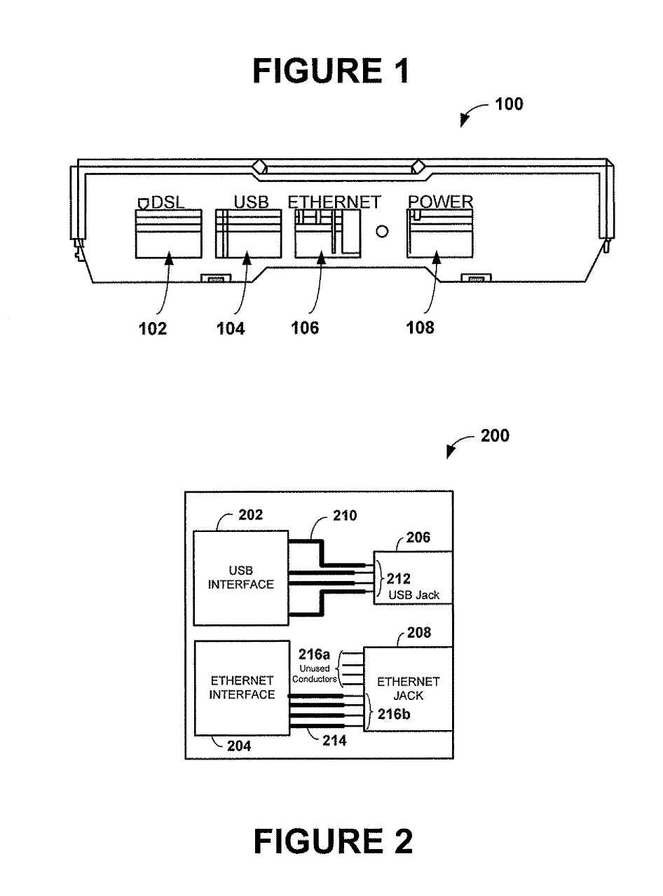

FIG. 1 is a block diagram of a modem 100, according to an example. As shown, the modem 100 includes a DSL jack 102, a USB jack 104, an Ethernet jack 106, and a power outlet 108. It should be understood that this and other arrangements described herein are set forth only as examples. Those skilled in the art will appreciate that other arrangements and elements (e.g., machines, interfaces, functions, orders, and groupings of functions, etc.) can be used instead, and that some elements may be omitted altogether.

As depicted, the modem 100 comprises a single-port DSL modem. However, the modem 100 may take any of a variety of configurations. As an example, the modem 100 may comprise a modem or gateway. As another example, the modem 100 may comprise a cable modem, an analog modem, and any combination of the above modems and/or gateways.

The modem 100 includes two different types of LAN-side interface jacks: the USB jack 104 and Ethernet jack 106. As noted above, the USB jack 104 and the Ethernet jack 106 are typically configured in an “either-or” configuration. That is, if the user interfaces to the Ethernet jack 106, the USB jack 104 is disabled. Likewise, if the user interfaces to the USB jack 104, the Ethernet jack 106 is disabled. Hence, operation of the modem 100 typically includes at least one inefficiency; namely, only one of the USB jack 104 and Ethernet jack 106 may be used at a time.

In addition to the above inefficiency, conductors relating to the Ethernet jack 106 are typically underutilized. To illustrate, FIG. 2 is a block diagram of a cabling configuration 200, according to an example. As shown in FIG. 2, the cabling configuration 200 includes a USB interface 202, an Ethernet interface 204, a USB jack 206, and an Ethernet jack 208. The USB jack 206 may be substantially similar to the USB jack 104 and the Ethernet jack 208 may be substantially similar to the Ethernet jack 106 so that the USB jack 206 and the Ethernet jack 208 are included within a modem. Further, the USB interface 202 and Ethernet interface 204 may included in a computer system such as a PC, server, or router, as examples. Thus, the cabling configuration 200 illustrates a PC connected to the modem, for example.

In typical modems, the USB jack 206 is a 4-conductor device and the Ethernet jack 208 is an 8-conductor device. As depicted, the USB jack 206 includes conductors 212 and the Ethernet jack 208 includes a first set of four conductors 216a and a second set of four conductors 216b. A cable 210 may be used to connect the USB interface 202 of a computer system to the USB jack 206. In particular, the cable 210 connects the USB interface 202 to conductors 212 of the USB jack 206. Similarly, a cable 214 may be used to connect the Ethernet interface 204 of the computer system to the Ethernet jack 208. In particular, the cable 214 connects the Ethernet interface 204 to the second set of four conductors 216b.

In 10/100baseT, non Power-Over-Ethernet applications, which is typically considered the common application relating to DSL modems, for example, all four of the conductors 212 for the USB jack 206 are required. But in such applications and perhaps other applications, only four of the eight conductors of the Ethernet jack 208 are utilized. Hence, conductors relating to the Ethernet jack 208 are typically underutilized.

### 2. System Architecture

As noted above, an apparatus and method are disclosed for optimizing use of a modem jack. In particular, by utilizing all eight conductors of an Ethernet jack, four of the conductors being used to carry Ethernet signals and the remaining four of the conductors being used to carry USB signals, a USB jack for the modem may become unnecessary and thus eliminated (e.g., the modem may be manufactured without a USB jack). As a result, a cost burden associated with manufacturing a modem, such as the modem 100, with the USB jack may be less.

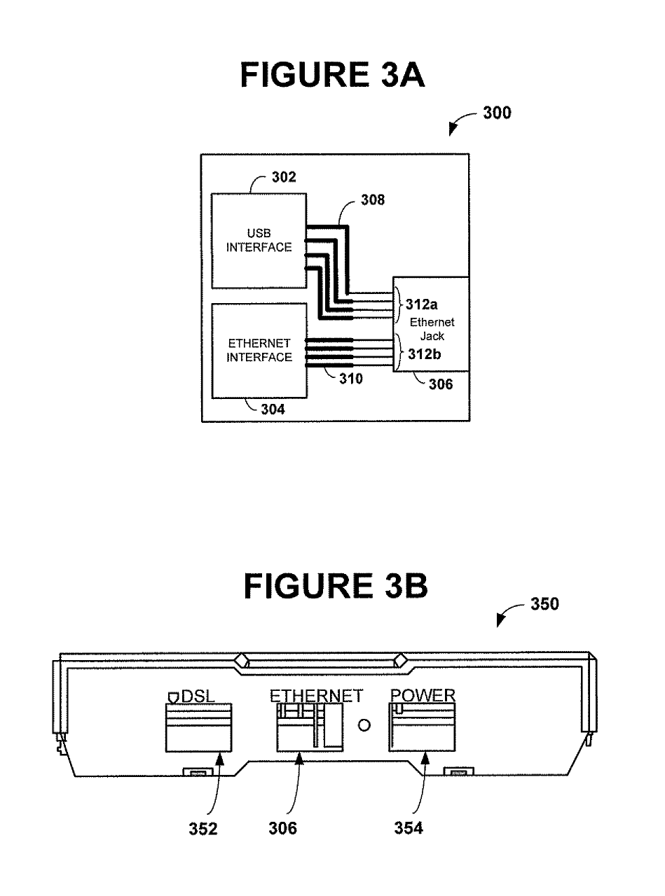

FIG. 3A is a block diagram of a cabling configuration 300, according to an example. As shown, the cabling configuration 300 includes a USB interface 302, an Ethernet interface 304, and an Ethernet jack 306. The USB and Ethernet interfaces 302 and 304, respectively, may be substantially similar to the USB and Ethernet interfaces 202 and 204, respectively. Further, the Ethernet jack 306 may be included as part of a modem, as an example. FIG. 3B is a block diagram of a modem 350, which includes the Ethernet jack 306. As shown, the modem 350 includes the Ethernet jack 306 at the exclusion of a USB jack. The modem 350 also includes a DSL jack 352 and a power jack 354.

As shown in FIG. 3A, the Ethernet jack 306 includes a first set of four conductors 312a and a second set of four conductors 312b. A cable 308 may be used to connect the USB interface 302 to the Ethernet jack 306 via the first set of four conductors 312a, and a cable 310 may be used to connect to Ethernet interface 304 to the Ethernet jack 306 via the second set of four conductors 312b. Since the USB interface 302 is connected to the first set of four conductors 312a, a separate USB jack may be unnecessary in the modem (as shown on modem 350). Hence, the cost burden associated with manufacturing a modem with a USB jack may be eliminated.

To further optimize use of the Ethernet jack 306, a single cable may be used instead of two cables to connect the USB and Ethernet interfaces 302 and 304, respectively, to the Ethernet jack 306. In other words, the cables 308 and 310 may be combined into a single cable. By using a single cable rather than two, a cost burden associated with using two separate cables may also be eliminated.

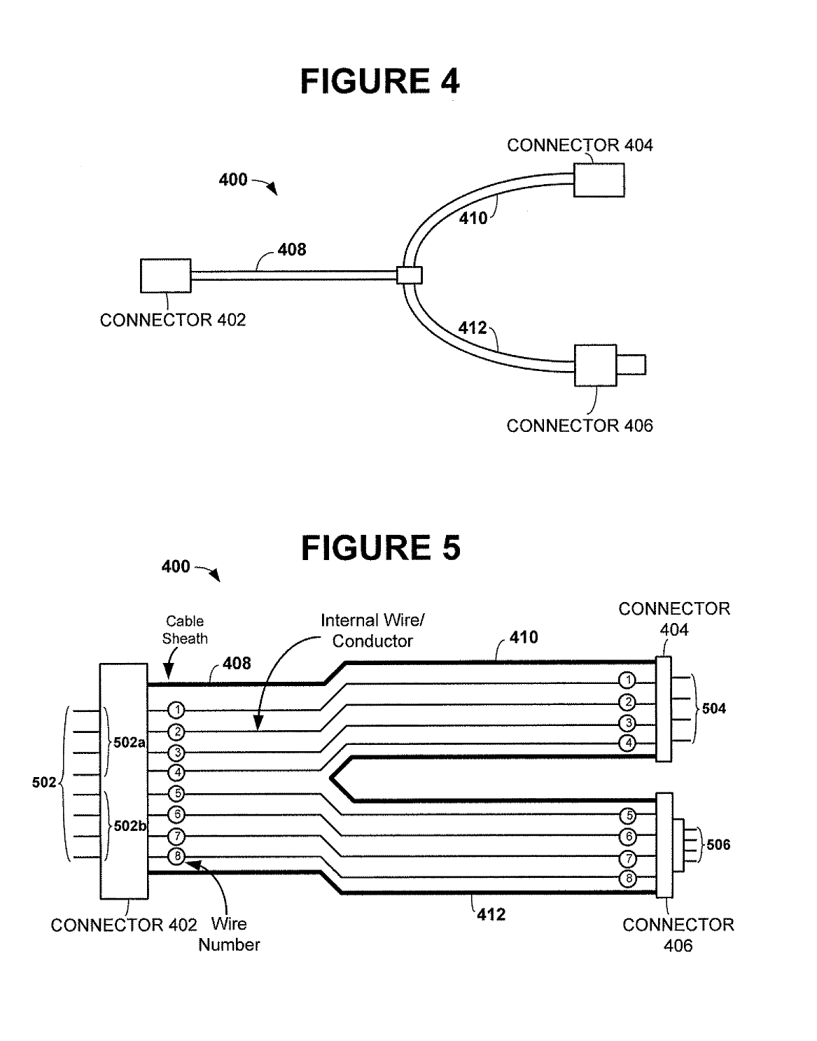

FIG. 4 is a block diagram of a cable 400, according to an example, that may be used to connect the USB interface 302 and Ethernet interface 304 to the Ethernet jack 306, As shown in FIG. 4, the cable 400 includes branch 408 that includes a connector 402, a branch 410 that includes a connector 404, and a branch 412 that includes a connector 406.

The connector 402 may be arranged to connect to the Ethernet jack 306, the connector 404 may be arranged to connect to the Ethernet interface 304, and the connector 406 may be arranged to connect to the USB interface 302. The branch 408 may be arranged to carry Ethernet and USB signals, the branch 410 may be arranged to carry Ethernet signals, and the branch 412 may be arranged to carry USB signals.

As shown in this example, the cable 400 includes a first end that includes the connector 402 and a split end that includes the connectors 404 and 406. Of course, other examples exist for the cable 400. For example, rather than being a single cable, the cable 400 may include a combination of cables with an adapter connecting the two. For instance, the cable 400 may be a standard Ethernet cable, and an adapter may be used to attach to one end of the cable 400 and mechanically split Ethernet and USB signals. Of course, other examples exist for the cable 400.

FIG. 5 is a block diagram of a schematic of the cable 400, according to an example. As shown, the cable 400 includes conducting wires 1 through 8. Any of the conducting wires 1 through 8 may take any of a variety of configurations, such as a 10/100baseT-cable-wiring and pin-out configuration. Of course, other examples exist for the conducting wires 1 though 8, and any combination of wiring configurations also exist for the conducting wires 1 though 8.

As shown, the branch 408 includes conducting wires 1 through 8, the branch 410 includes conducting wires 1 through 4, and the branch 412 includes conducting wires 5 through 8. The conducting wires 1 through 4 may be arranged to carry Ethernet signals and the conducting wires 5 through 8 may be arranged to carry USB signals. Hence, the branch 408 may be arranged to carry Ethernet and USB signals, the branch 410 may be arranged to carry Ethernet signals, and the branch 412 may be arranged to carry USB signals.

Also as shown, the connector 402 includes a set of eight conductor pins 502. The set of eight conductor pins 502 may include pins 502a and 502b. The pins 502a may be used to carry Ethernet signals and the pins 502b may be used to carry USB signals. Further, the set of eight conductor pins 502 may be arranged to connect to the first and second set of conductors 312a and 312b of the Ethernet jack 306. In particular, the pins 502a may be arranged to connect to the second set of conductors 312b and the pins 502b may be arranged to connect to the first set of conductors 312a.

Additionally, the connector 404 may include a set of four conductor pins 504 and the connector 406 may include a set of four conductor pins 506. The set of four conductor pins 504 may be arranged to connect to conductors (not shown) corresponding to the Ethernet interface 304 and the set of four conductor pins 506 may be arranged to connect to conductors (not shown) corresponding to the USB interface 302. Of course, other examples exist for the connectors 402, 404, and 406.

Generally, the connectors 402, 404, and 406, the Ethernet jack 306, the USB interface 302, and the Ethernet interface 304 are arranged to respectively mechanically and electrically couple with one another. To such an extent, the connectors 402, 404, and 406, the Ethernet jack 306, the USB interface 302, and the Ethernet interface 304 may take any of a variety of configurations. As described above, the connectors 402, 404, and 406 are shown to include respective conductor pins and the Ethernet jack 306, for instance, is shown to include conductors. Those skilled in the art will understand that other arrangements are also possible. For example, the connectors 402, 404, and 406 may include conductors and the Ethernet jack 306 may include conductor pins. Of course, other combinations also exist, so long as the connectors 402, 404, and 406, the Ethernet jack 306, the USB interface 302, and the Ethernet interface 304 are arranged to respectively mechanically and electrically couple with one another.

### 3. Methodology

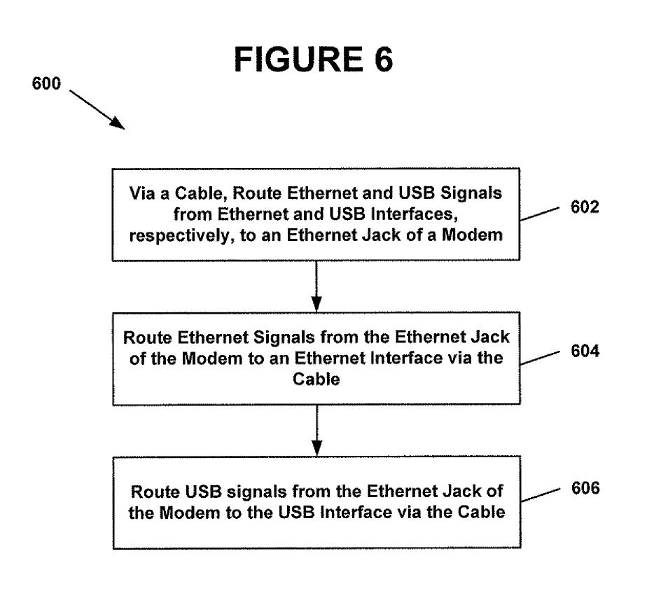

FIG. 6 is a flow chart of a method 600 for optimizing use of a modem jack. Two or more of the functions shown in FIG. 6 may occur substantially simultaneously. Further, not all of the functions shown in FIG. 6 are required in order to carry out the method 600.

At block 602, the method includes, via a cable (e.g., cable 400), routing Ethernet and USB signals from Ethernet and USB interfaces (e.g., Ethernet interface 304 and USB interface 302), respectively, to an Ethernet jack (e.g., Ethernet jack 306) of a modem (e.g., modem 350). The cable may include (i) a first branch (e.g., branch 408) that includes a first end (e.g., connector 402) arranged to connect to the Ethernet jack of the modem, (ii) a second branch (e.g., branch 410) that includes a second end (e.g., connector 404) arranged to connect to the Ethernet interface, and (iii) a third branch (e.g., branch 412) that includes a third end (e.g., connector 406) arranged to connect to the USB interface.

The first end of the cable may take any of a variety of configurations. For example, the first end may include eight conductor pins (e.g., conductor pins 502). Further, the Ethernet jack of the modem may include eight conductors (e.g., the first set of conductors 312a and the second set of conductors 312b). The eight conductor pins of the first end may be arranged to connect to the eight conductors of the Ethernet jack. Further, four of the eight conductor pins (e.g., conductors 502a) of the first end may be used to carry Ethernet signals, and the remaining four of the eight conductor pins (e.g., conductors 502b) of the first end may be used to carry USB signals. Of course, other examples exist for the first end and Ethernet jack.

Routing Ethernet and USB signals from the Ethernet and USB interfaces, respectively, to the Ethernet jack of the modem may include enabling the first branch to carry Ethernet and USB signals. To illustrate, the first branch may include any number and variety of conducting wires. For instance, the first branch may include eight conducting wires (e.g., conducting wires 1 through 8). The eight conducting wires of the first branch may be cooperatively arranged to carry Ethernet and USB signals.

At block 604, the method includes routing Ethernet signals from the Ethernet jack of the modem to an Ethernet interface via the cable. Routing Ethernet signals from the Ethernet jack of the modem to the Ethernet interface via the cable may include enabling the second branch to carry Ethernet signals. To illustrate, the second branch may include four of the eight conducting wires (e.g., conducting wires 1 through 4). The four of the eight conducting wires of the second branch may be arranged to carry Ethernet signals.

At block 606, the method includes routing USB signals from the Ethernet jack of the modem to the USB interface via the cable. Routing USB signals from the Ethernet jack of the modem to the USB interface via the cable may include enabling the third branch to carry USB signals. To illustrate, the third branch may include the remaining four of the eight conducting wires (e.g., conducting wires 5 through 8). The remaining four of the eight conducting wires of the third branch may be arranged to carry USE signals.

### 4. Conclusion

An apparatus and method for optimizing use of a modem have been disclosed. In particular, by utilizing all eight conductors (or conductor pins) of an Ethernet jack, four of the conductors being used to carry Ethernet signals and the remaining four of the conductors being used to carry USB signals, a USB jack for the modem may become unnecessary and may thus be eliminated. As a result, the cost burden associated with manufacturing a modem with a USB jack may be eliminated. Additionally, by using a single cable to connect USB and Ethernet interfaces of a computer system to the Ethernet jack of the modem, the cost burden associated with using two separate cables may also be eliminated.

Embodiments of the present application have been described above. Those skilled in the art will understand, however, that changes and modifications may be made to the embodiments described without departing from the true scope and spirit of the present invention, which is defined by the claims.

What is claimed is:

1. An apparatus for optimizing use of a modem jack, the apparatus comprising:
a first branch including a first end that is arranged to connect to an Ethernet jack of a modem;
a second branch connected to the first branch, the second branch including a second end that is arranged to connect to an Ethernet interface of a computer system; and
a third branch connected to the first branch, the third branch including a third end that is arranged to connect to a USB interface of the computer system.

2. The apparatus of claim 1, wherein the first branch is arranged to carry Ethernet and USB signals, wherein the second branch is arranged to carry Ethernet signals, and wherein the third branch is arranged to carry USB signals.

3. The apparatus of claim 1, wherein the first end includes eight conductor pins, wherein the Ethernet jack of the modem includes eight conductors, and wherein the eight conductor pins of the first end are arranged to connect to the eight conductors of the Ethernet jack.

4. The apparatus of claim 3, wherein four of the eight conductor pins of the first end are used for Ethernet signals, and wherein the remaining four of the eight conductor pins of the first end are used for USB signals.

5. The apparatus of claim 4, wherein the four of the eight conductor pins used for Ethernet signals are arranged to connect to four of the eight conductors of the Ethernet jack, and wherein the remaining four of the eight conductor pins used for USB signals are arranged to connect to the remaining four of the eight conductors of the Ethernet jack.

6. The apparatus of claim 1, wherein the second end includes a first group of conductor pins arranged to connect to the Ethernet interface of the computer system, and wherein the third end includes a second group of conductor pins arranged to connect to the USB interface of the computer system.

7. The apparatus of claim 1, wherein the first branch includes a first portion of eight conducting wires, wherein the second branch includes a second portion of four of the eight conducting wires, and wherein the third branch includes a second portion of the remaining four of the eight conducting wires.

8. The apparatus of claim 7, wherein the eight conducting wires of the first branch are cooperatively arranged to carry Ethernet and USB signals, wherein the four of the eight conducting wires of the second branch are arranged to carry Ethernet signals, and wherein the remaining four of the eight conducting wires of the third branch are arranged to carry USB signals.

9. The apparatus of claim 1, wherein the modem includes at least one of a DSL modem, a cable modem, and an analog modem.

10. The apparatus of claim 1, wherein the first branch and the second branch include a 10/100baseT-cable-wiring and pin-out configuration.

11. The apparatus of claim 1, wherein the modem includes the Ethernet jack at the exclusion of a USB jack.

12. In a computer system that includes an Ethernet interface, a USB interface, and a modem, a method for optimizing use of a modem jack, the method comprising:
routing Ethernet and USB signals from the Ethernet and USB interfaces, respectively, to an Ethernet jack of the modem via a cable;
routing Ethernet signals from the Ethernet jack of the modem to the Ethernet interface via the cable; and
routing USB signals from the Ethernet jack of the modem to the USB interface via the cable.

13. The method of claim 12, wherein the cable includes (i) a first branch that includes a first end arranged to connect to the Ethernet jack of the modem, (ii) a second branch that includes a second end arranged to connect to the Ethernet interface, and (iii) a third branch that includes a third end arranged to connect to the USB interface.

14. The method of claim 13, wherein routing Ethernet and USB signals from the Ethernet and USB interfaces, respectively, to the Ethernet jack of the modem comprises enabling the first branch to carry Ethernet and USB signals.

15. The method of claim 13, wherein routing Ethernet signals from the Ethernet jack of the modem to the Ethernet interface via the cable comprises enabling the second branch to carry Ethernet signals.

16. The method of claim 13, wherein routing USE signals from the Ethernet jack of the modem to the USB interface via the cable comprises enabling the third branch to carry USB signals.

17. The method of claim 13, wherein the first end includes eight conductor pins, wherein the Ethernet jack of the modem includes eight conductors, wherein the eight conductor pins of the first end are arranged to connect to the eight conductors of the Ethernet jack.

18. The method of claim 12, wherein the first branch includes eight conducting wires, wherein the second branch includes four of the eight conducting wires, wherein the third branch includes the remaining four of the eight conducting wires, wherein the eight conducting wires of the first branch are cooperatively arranged to carry Ethernet and USB signals, wherein the four of the eight conducting wires of the second branch are arranged to carry Ethernet signals, and wherein the remaining four of the eight conducting wires of the third branch are arranged to carry USB signals.

19. The method of claim 12, wherein the modem includes the Ethernet jack at the exclusion of a USB jack.

20. An apparatus for optimizing use of a modem jack, the apparatus comprising:
a first end arranged to connect to an Ethernet jack of a modem, wherein the modem includes the Ethernet jack at the exclusion of a USB jack; and
a split-end connected to the first end, the split-end including (i) a second end arranged to connect to an Ethernet interface of a computer system and (ii) a third end arranged to connect to a USB interface of the computer system.
